(19) United States
(12) Patent Application Publication
(10) Pub. No.: US 2018/0157262 A1
(43) Pub. Date: Jun. 7, 2018

(54) VEHICLE CONTROL SYSTEM, SERVER DEVICE, VEHICLE CONTROL METHOD, AND VEHICLE CONTROL PROGRAM

(71) Applicant: HONDA MOTOR CO., LTD, Tokyo (JP)

(72) Inventors: Tsutomu Ao, Utsunomiya-shi (JP); Naotoshi Fujimoto, Utsunomiya-shi (JP); Genta Boda, Utsunomiya-shi (JP)

(21) Appl. No.: 15/730,862

(22) Filed: Oct. 12, 2017

(30) Foreign Application Priority Data
Dec. 2, 2016 (JP) 2016-235048

(51) Int. Cl. G05D 1/02; B60W 30/12; B60W 10/20

(52) U.S. Cl. CPC G05D 1/0212; G05D 1/0257; G05D 1/0231; B60W 2550/10; B60W 10/20; B60W 2720/24; B60W 30/12

(57) ABSTRACT

A vehicle control system includes a travel route acquisition unit configured to acquire a travel route, on which a vehicle can travel, from an external device, and a travel control unit configured to at least partly automatically perform travel control of the vehicle and to cause the vehicle to travel on the basis of the travel route acquired by the travel route acquisition unit.

### CROSS-REFERENCE TO RELATED APPLICATION

Priority is claimed on Japanese Patent Application No. 2016-235048, filed Dec. 2, 2016, the content of which is incorporated herein by reference.

### BACKGROUND OF THE INVENTION

### Field of the Invention

The present invention relates to a vehicle control system, a server device, a vehicle control method, and a vehicle control program.

### Description of Related Art

In the related art, a navigation device that suggests either or both of eating establishments or tourist facilities located within a predetermined range from the current position of a vehicle has been disclosed (for example, see Japanese Unexamined Patent Application, First Publication No. 2012-57955).

### SUMMARY OF THE INVENTION

However, a technology for suggesting a travel route on which it is possible to travel by automated driving has not been disclosed in the related art.

Aspects of the present invention have been made in view of the above circumstances and it is an object of the present invention to provide a vehicle control system, a server device, a vehicle control method, and a vehicle control program which can cause a vehicle to be automatically driven on a travel route desired by an occupant.

In order to achieve the above object, the present invention adopts the following aspects.

(1) A vehicle control system according to an aspect of the present invention includes a travel route acquisition unit configured to acquire a travel route, on which a vehicle can travel, from an external device, and a travel control unit configured to at least partly automatically perform travel control of the vehicle and to cause the vehicle to travel on the basis of the travel route acquired by the travel route acquisition unit.

(2) In the above aspect (1), the travel route acquisition unit may be configured to acquire, together with the travel route, guide information regarding a feature that can be seen from the travel route or a facility at which it is possible to stop along the travel route.

(3) In the above aspect (2), the guide information may include detailed travel information of the vehicle on the travel route.

(4) In the above aspect (3), the detailed travel information may include information regarding a recommended lane.

(5) In the above aspect (3), the detailed travel information may include a proportion of actual vehicle travel in a recommended lane.

(6) In any one of the above aspects (2) to (5), the travel route acquisition unit may be configured to determine whether or not the vehicle is located on or near the travel route and to acquire the guide information from the external device on the basis of a result of the determination.

(7) In any one of the above aspects (1) to (6), the vehicle control system may further include a position information acquisition unit configured to acquire position information of the vehicle, and the travel route acquisition unit may be configured to acquire, from the external device, a travel route, on which it is possible to travel at a predetermined time, using the position information of the vehicle acquired by the position information acquisition unit.

(8) In any one of the above aspects (1) to (7), the vehicle control system may further include an interface unit configured to receive an operation from an occupant of the vehicle, and, when an operation of starting provision of original information of the travel information is received through the interface unit, the position information of the vehicle may be transmitted to the external device until the occupant performs an operation of ending provision of the original information of the travel route.

(9) A vehicle control system according to an aspect of the present invention includes a travel route acquisition unit configured to acquire a travel route, on which a vehicle can travel, from an external device, a determination unit configured to determine whether or not it is possible to travel by automated driving on the travel route acquired by the travel route acquisition unit, and a travel control unit configured to at least partly automatically perform travel control of the vehicle and to cause the vehicle to travel on the basis of the travel route acquired by the travel route acquisition unit when the determination unit has determined that it is possible to travel by automated driving.

(10) A vehicle control system according to an aspect of the present invention includes a travel route acquisition unit configured to acquire a travel route, on which a vehicle can travel, from an external device, a region acquisition unit configured to acquire a region in which it is possible to travel by automated driving in the travel route acquired by the travel route acquisition unit, and a travel control unit configured to at least partly automatically perform travel control of the vehicle and to cause the vehicle to travel in the region acquired by the region acquisition unit.

(11) A server device according to an aspect of the present invention includes a travel information acquisition unit configured to acquire original information of a travel route, on which it is possible to travel by automated driving, from a vehicle, a travel route generation unit configured to generate a travel route on which it is possible to travel by automated driving on the basis of information acquired by the travel information acquisition unit, and a distribution unit configured to distribute the travel route generated by the travel route generation unit to the vehicle.

(12) In the above aspect (11), the server device may further include a guide information generation unit configured to generate guide information corresponding to the travel route generated by the travel route generation unit, and the distribution unit may be configured to further distribute the guide information corresponding to the travel route to the vehicle.

(13) In the above aspect (11) or (12), the server device may further include a communication unit configured to communicate with a terminal device of a user of the vehicle, and the distribution unit may be configured to start distributing the travel route generated by the travel route generation unit to the vehicle recognized by communication with the terminal device on the basis of a start instruction from the terminal device.

(14) A vehicle control method according to an aspect of the present invention causes a vehicle-mounted computer to acquire a travel route, on which a vehicle can travel, from an external device and to at least partly automatically perform travel control of the vehicle and to cause the vehicle to travel on the basis of the acquired travel route.

(15) A vehicle control program according to an aspect of the present invention causes a vehicle-mounted computer to acquire a travel route, on which a vehicle can travel, from an external device and to at least partly automatically perform travel control of the vehicle and to cause the vehicle to travel on the basis of the acquired travel route.

According to the above aspects (1), (9), (10), (14), and (15), the vehicle control system can cause the vehicle to be automatically driven on the travel route desired by the occupant.

According to the above aspects (2) to (5), the vehicle control system can provide information regarding the travel route to the occupant during automated driving along the travel route.

According to the above aspect (6), it is possible to acquire more information regarding the travel route.

According to the above aspect (7), the vehicle control system can provide the occupant with a travel plan which makes it possible to effectively use idle time or the like.

According to the above aspect (8), the vehicle control system can cause the external device to generate a travel route on the basis of continuous position information of the vehicle.

According to the above aspect (11), the server device can distribute a travel route for automated driving generated from information of travel that the vehicle has actually performed, thereby allowing the vehicle to be automatically driven according to actual road states or the like.

According to the above aspects (12) and (13), the server device can provide high value-added services to the occupant of the vehicle.

### BRIEF DESCRIPTION OF THE DRAWINGS

FIG. 1 is a configuration diagram of a vehicle system 1 including an automated driving control unit 100 according to an embodiment.

FIG. 2 is a diagram showing how the relative position and attitude of an own-vehicle M with respect to a traveling lane L1 are recognized by an own-vehicle position recognition unit 122.

FIG. 3 is a diagram showing how a target trajectory is generated on the basis of a recommended lane.

FIG. 4 is a diagram showing an example of a configuration of a traffic information sharing system 300.

FIG. 5 is a diagram showing an example of an automated driving travel route DB 682.

FIG. 6 is a diagram showing an example of a guide information DB 684.

FIG. 7 is a diagram showing an example of a billing DB 686.

FIG. 8 is a diagram showing an example of a search screen 700 for an automated driving travel route displayed on a display device 31.

FIG. 9 is a diagram showing an example of a search result screen displayed on the display device 31.

FIG. 10 is a diagram showing an example of a travel information provision screen.

FIG. 11 is a diagram showing an example of a screen displayed on the display device 31 during provision of travel information.

FIG. 12 is a flowchart showing an example of a process of acquiring an automated driving travel route.

FIG. 13 is a flowchart showing an example of a process of providing travel information.

FIG. 14 is a flowchart showing an example of a process of sharing traffic information in a server device 600.

### DETAILED DESCRIPTION OF THE INVENTION

Hereinafter, a vehicle control system, a server device, a vehicle control method, and a vehicle control program according to an embodiment will be described with reference to the drawings. In the embodiment, it is assumed that the vehicle control system is applied to an automated driving vehicle. Automated driving is, for example, automatic control of at least one of acceleration/deceleration or steering of a vehicle to drive the vehicle.

### [Overall Configuration]

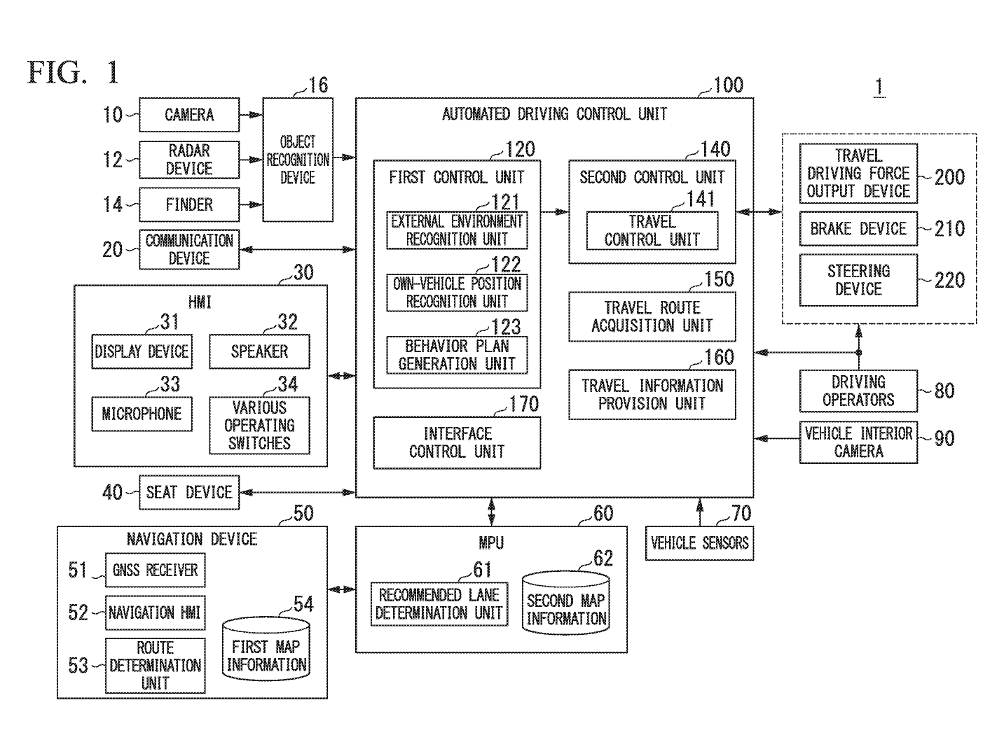

FIG. 1 is a configuration diagram of a vehicle system 1 including an automated driving control unit 100 according to the embodiment. A vehicle on which the vehicle system 1 is mounted (hereinafter referred to as an own-vehicle M) is, for example, a vehicle such as a two-wheeled vehicle, a three-wheeled vehicle, or a four-wheeled vehicle, and a driving source thereof is an internal combustion engine such as a diesel engine or a gasoline engine, an electric motor, or a combination thereof. The electric motor operates using electric power generated by a generator connected to the internal combustion engine or using discharge power of a secondary battery or a fuel cell.

The vehicle system 1 includes, for example, a camera (an image capturing unit) 10, a radar device 12, a finder 14, an object recognition device 16, a communication device 20, a human machine interface (HMI) 30, a seat device 40, a navigation device 50, a micro-processing unit (MPU) 60, vehicle sensors 70, driving operators 80, a vehicle interior camera 90, an automated driving control unit 100, a travel driving force output device 200, a brake device 210, and a steering device 220. These devices or apparatuses are connected to each other by a multiplex communication line or a serial communication line such as a controller area network (CAN) communication line, a wireless communication network, or the like. Note that the components shown in FIG. 1 are merely an example and some of the components may be omitted or other components may be added. The “vehicle control system” includes, for example, a communication device 20, an HMI 30, a seat device 40, and an automated driving control unit 100. All or part of the navigation device 50 and an own-vehicle position recognition unit 122, which will be described later, is an example of a “position information acquisition unit.” In addition, all or part of the HMI 30 and an interface control unit 170, which will be described later, is an example of an “interface unit.”

The camera 10 is, for example, a digital camera using a solid-state imaging device such as a charge coupled device (CCD) or complementary metal oxide semiconductor (CMOS) image sensor. One or a plurality of cameras 10 may be attached to a vehicle (hereinafter referred to as an “own-vehicle M”) on which the vehicle system 1 is mounted, at arbitrary locations. For imaging the area in front of the vehicle, a camera 10 is attached to an upper portion of a front windshield, a rear surface of a rearview mirror, or the like. For imaging the area behind the vehicle, a camera 10 is attached to an upper portion of a rear windshield, a back door, or the like. For imaging the area to the side of the vehicle, a camera 10 is attached to a door mirror or the like. For example, the camera 10 repeats imaging of the periphery of the own-vehicle M at regular intervals. The camera 10 may be a stereo camera. The camera 10 may also be an omnidirectional camera which is capable of imaging areas in all horizontal directions (360°) of the own-vehicle M.

The radar device 12 radiates radio waves such as millimeter waves around the own-vehicle M and detects radio waves reflected by an object (reflected waves) to detect at least the position (distance and orientation) of the object. One or a plurality of radar devices 12 may be attached to the own-vehicle M at arbitrary locations. The radar device 12 may detect the position and velocity of an object using a frequency modulated continuous wave (FM-CW) method.

The finder 14 is a light detection and ranging or laser imaging detection and ranging (LIDAR) finder which measures scattered light from an object in response to illuminated light to detect the distance to the object. One or a plurality of finders 14 may be attached to the own-vehicle M at arbitrary locations.

The object recognition device 16 performs a sensor fusion process on results of detection by some or all of the camera 10, the radar device 12, and the tinder 14 to recognize the position, type, speed, or the like of the object. The object recognition device 16 outputs the recognition result to the automated driving control unit 100.

For example, the communication device 20 communicates with other vehicles near the own-vehicle M using a cellular network, a Wi-Fi network, Bluetooth (registered trademark), dedicated short range communication (DSRC) or the like or communicates with various server devices via wireless base stations.

The HMI 30 presents various types of information to an occupant in the vehicle and receives an input operation from the occupant. The HMI 30 includes, for example, a display device 31, a speaker 32, a microphone 33, and various operating switches 34.

The display device 31 is a liquid crystal display (LCD), an organic electro-luminescence (EL) display device, or the like. The display device 31 is, for example, a touch panel type display device having a function of displaying an image and a function of receiving the approaching position or the content of an operation of an operator's finger with respect to the display surface. For example, the speaker 32 outputs a sound based on content displayed on the display device 31, outputs a sound of guide information regarding a travel route during automated driving, or outputs an alarm or the like. The microphone 33 receives, for example, voice of an occupant of the own-vehicle M.

The various operating switches 34 are arranged in the own-vehicle M at arbitrary locations. The various operating switches 34 include, for example, an automated driving changeover switch. The automated driving changeover switch is a switch allowing an occupant to issue an instruction to start automated driving (or to start automated driving in the future) and an instruction to stop automated driving. The various operating switches 34 may be any of graphical user interface (GUI) switches and mechanical switches.

The seat device 40 includes seats on which occupants of the own-vehicle M sit and which are electrically drivable. For example, the seat device 40 drives a motor or the like for a seat on the basis of an instruction from the interface control unit 170 to freely adjust the reclining angle, the forward-backward position, the lateral position, or the vertical position of the seat, a yaw angle indicating the rotation angle of the seat, or the like. The seat device 40 includes a driver's seat on which the driver sits to drive the own-vehicle M manually using the driving operators 80, a front occupant seat alongside the driver's seat, rear seats behind the driver's seat and the front occupant seat, etc. In the following description, “seat device 40” refers to as at least one of the driver's seat, the front occupant seat, and the rear seats unless otherwise specified.

The navigation device 50 includes, for example, a global navigation satellite system (GNSS) receiver 51, a navigation HMI 52, and a route determination unit 53 and holds first map information 54 in a storage device such as a hard disk drive (HDD) or a flash memory. The GNSS receiver specifies the position of the own-vehicle M on the basis of signals received from GNSS satellites. The position of the own-vehicle M may also be specified or supplemented by an inertial navigation system (INS) using the output of the vehicle sensors 70. The navigation HMI 52 includes a display device, a speaker, a touch panel, a key, or the like. The navigation HMI 52 may be partly or wholly shared with the HMI 30 described above. For example, the route determination unit 53 determines a route from the position of the own-vehicle M specified by the GNSS receiver 51 (or an arbitrary input position) to a destination input by the occupant using the navigation HMI 52 by referring to the first map information 54. The first map information 54 is, for example, information representing shapes of roads by links indicating roads and nodes connected by the links. The first map information 54 may include curvatures of roads, point of interest (POI) information, or the like. The route determined by the route determination unit 53 is output to the MPU 60. The navigation device 50 may also perform route guidance using the navigation HMI 52 on the basis of the route determined by the route determination unit 53. The navigation device 50 may be realized, for example, by a function of a terminal device such as a smartphone or a tablet possessed by the user. The navigation device 50 may also transmit the current position and the destination to a navigation server via the communication device 20 and acquire a route returned from the navigation server.

The MPU 60 functions, for example, as a recommended lane determination unit 61 and holds the second map information 62 in a storage device such as an HDD or a flash memory. The recommended lane determination unit 61 divides the route provided from the navigation device 50 into a plurality of blocks (for example, into blocks each 100 meters long in the direction in which the vehicle travels) and determines a recommended lane for each block by referring to the second map information 62. The recommended lane determination unit 61 determines the recommended lane such that the recommended lane is given a position in a lane order counted from the leftmost lane. When there is a branch point, a merge point, or the like on the route, the recommended lane determination unit 61 determines a recommended lane such that the own-vehicle M can travel on a reasonable travel route for proceeding to the branch destination.

The second map information 62 is map information with higher accuracy than the first map information 54. The second map information 62 includes, for example, information of the centers of lanes or information of the boundaries of lanes. The second map information 62 may also include road information, traffic regulation information, address information (addresses/postal codes), facility information, telephone number information, or the like. The road information includes information indicating the types of roads such as expressways, toll roads, national roads, or prefectural roads or information such as the number of lanes of each road, regions of emergency parking zones, the widths of lanes, the gradients of roads, the positions of roads (three-dimensional coordinates including longitude, latitude and height), the curvatures of curves of lanes, the positions of merge or branch points of lanes, signs installed on roads, or the like. The second map information 62 may be updated as needed by accessing another device using the communication device 20.

The vehicle sensors 70 include a vehicle speed sensor that detects the speed of the own-vehicle M, an acceleration sensor that detects the acceleration thereof, a yaw rate sensor that detects an angular speed thereof about the vertical axis, an orientation sensor that detects the orientation of the own-vehicle M, or the like. The vehicle sensors 70 also include a brake failure detection sensor that detects brake actuator deterioration or the like of the brake device 210, an air pressure sensor that detects whether or not the air pressure of a tire during traveling is equal to or less than a threshold value, or the like.

The driving operators 80 include, for example, an accelerator pedal, a brake pedal, a shift lever, a steering wheel, and other operators. A sensor for detecting the amount of operation or the presence or absence of operation is attached to each of the driving operators 80 and detection results thereof are output to either or both of the automated driving control unit 100 or the travel driving force output, brake, and steering devices 200, 210, and 220.

The vehicle interior camera 90 captures an image of the upper body around the face of an occupant sitting on the driver's seat. The captured image of the vehicle interior camera 90 is output to the automated driving control unit 100.

### [Automated Driving Control Unit]

The automated driving control unit 100 includes, for example, a first control unit 120, a second control unit 140, a travel route acquisition unit 150, a travel information provision unit (information provision unit) 160, and an interface control unit 170. Each of the first control unit 120, the second control unit 140, the travel route acquisition unit 150, the travel information provision unit 160, and the interface control unit 170 is realized by a processor such as a central processing unit (CPU) executing a program (software). Some or all of the first control unit 120, the second control unit 140, the travel route acquisition unit 150, the travel information provision unit 160, and the interface control unit 170 may be realized by hardware such as a large scale integration (LSI), an application specific integrated circuit (ASIC), or a field-programmable gate array (FPGA) or may be realized by cooperation of hardware and software.

A unit including all or part of an external environment recognition unit 121, an own-vehicle position recognition unit 122 and a behavior plan generation unit 123 of the first control unit 120, and a travel control unit 141 of the second control unit 140 which will be described later is an example of a “travel control unit.” All or part of the behavior plan generation unit 123 is an example of a “determining unit” or a “region acquisition unit.”

The first control unit 120 includes, for example, an external environment recognition unit 121, an own-vehicle position recognition unit 122, and a behavior plan generation unit 123.

The external environment recognition unit 121 recognizes states of a nearby vehicle(s) such as the position, speed and acceleration thereof on the basis of information input from the camera 10, the radar device 12, and the finder 14 via the object recognition device 16. The position of the nearby vehicle may be represented by a representative point such as a center of gravity or a corner of the nearby vehicle or may be represented by a region expressed by a contour of the nearby vehicle. The “states” of the nearby vehicle may include acceleration or jerk of the nearby vehicle or a “behavior state” (for example, whether or not the nearby vehicle is changing or is going to change lanes).

The external environment recognition unit 121 may also recognize the positions of guardrails or utility poles, parked vehicles, pedestrians, and other objects in addition to nearby vehicles. In this case, the external environment recognition unit 121 determines whether or not there is an obstacle at a position at which the own-vehicle M is scheduled to stop during automated driving, for example, on the basis of a result of recognition by the object recognition device 16. The obstacle is another vehicle, a pedestrian, or any other object. Upon determining that there is an obstacle at the scheduled stop position, the external environment recognition unit 121 instructs the behavior plan generation unit 123 to change the target trajectory.

The own-vehicle position recognition unit 122 recognizes, for example, a (traveling) lane in which the own-vehicle M is traveling and the relative position and attitude of the own-vehicle M with respect to the traveling lane. The own-vehicle position recognition unit 122 recognizes the traveling lane, for example, by comparing a pattern of road lane lines (for example, an arrangement of solid and broken lines) obtained from the second map information 62 with a pattern of road lane lines near the own-vehicle M recognized from an image captured by the camera 10. This recognition may be performed taking into consideration a position of the own-vehicle M acquired from the navigation device 50 or a result of processing by the INS.

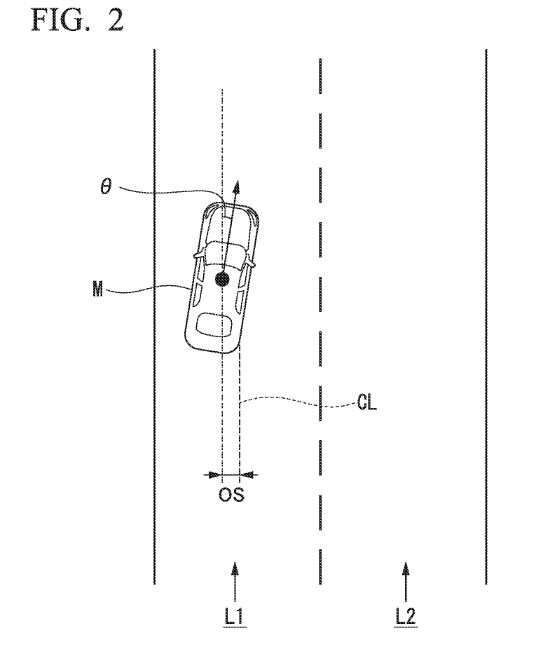

Then, the own-vehicle position recognition unit 122 recognizes, for example, the relative position or attitude of the own-vehicle M with respect to the traveling lane. FIG. 2 is a diagram showing how the relative position and attitude of the own-vehicle M with respect to the traveling lane L1 are recognized by the own-vehicle position recognition unit 122. For example, the own-vehicle position recognition unit 122 recognizes both a deviation OS from a traveling lane center CL of a reference point (for example, the center of gravity) of the own-vehicle M and an angle θ formed by the travel direction of the own-vehicle M relative to an extension line of the traveling lane center CL as the relative position and attitude of the own-vehicle M with respect to the traveling lane L1. Alternatively, the own-vehicle position recognition unit 122 may recognize, for example, the position of the reference point of the own-vehicle M with respect to one of the sides of the traveling lane L or the like as the relative position of the own-vehicle M with respect to the traveling lane. The relative position of the own-vehicle M recognized by the own-vehicle position recognition unit 122 is provided to the recommended lane determination unit 61 and the behavior plan generation unit 123.

The behavior plan generation unit 123 generates a behavior plan for the own-vehicle M to perform automated driving to the destination or the like. For example, the behavior plan generation unit 123 determines events which are to be sequentially performed in the automated driving such that the own-vehicle M travels in the recommended lane determined by the recommended lane determination unit 61 and copes with situations occurring near the own-vehicle M. The events include, for example, a constant-speed travel event which is an event of traveling in the same traveling lane at a constant speed, a following travel event which is an event of traveling behind a preceding vehicle, a lane change event, a merging event, a branching event, an emergency stop event, and a handover event which is an event of terminating automated driving and switching to manual driving. During execution of these events, behaviors for avoidance may sometimes be planned on the basis of situations occurring near the own-vehicle M (such as the presence of nearby vehicles and pedestrians or lane narrowing due to road construction).

The behavior plan generation unit 123 generates a target trajectory along which the own-vehicle M will travel in the future. The target trajectory includes, for example, velocity components. For example, the target trajectory is generated as a set of target points (trajectory points) to be reached at a plurality of future reference times which are set at intervals of a predetermined sampling time (for example, about tenths of a second). Therefore, when the distance between trajectory points is great, this means that the vehicle travels at a high speed in the section between the trajectory points.

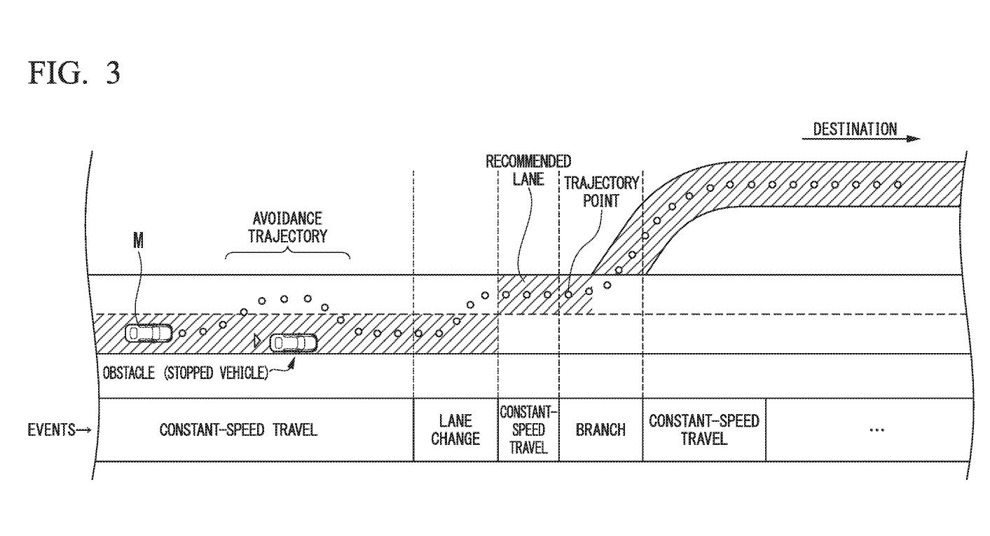

FIG. 3 is a diagram showing how a target trajectory is generated on the basis of a recommended lane. As shown, the recommended lane is set to be convenient for traveling along the route to the destination.

When the own-vehicle M approaches a predetermined distance (which may be determined according to the types of events) before a point for switching to the recommended lane, the behavior plan generation unit 123 activates a lane change event, a branching event, a merging event, or the like. When it becomes necessary to avoid an obstacle during execution of each event, an avoidance trajectory is generated as shown in FIG. 3.

For example, the behavior plan generation unit 123 generates a plurality of candidate target trajectories and selects an optimum target trajectory at that time in view of safety and efficiency.

The behavior plan generation unit 123 may also generate a target trajectory to the destination on the basis of travel route information acquired by the travel route acquisition unit 150 as will be described later.

The second control unit 140 includes, for example, a travel control unit 141. The travel control unit 141 controls the travel driving force output device 200, the brake device 210, and the steering device 220 such that the own-vehicle M passes through the target trajectory generated by the behavior plan generation unit 123 at scheduled times. The travel control unit 141 may at least partly automatically perform travel control of the own-vehicle M and may cause the own-vehicle M to travel on the basis of a travel route acquired by the travel route acquisition unit 150.

The travel route acquisition unit 150 acquires a travel route for automated driving (also referred to as an automated driving travel route) from an external device. The external device is, for example, a server device connected to the own-vehicle M via a network. The external device may also be another vehicle which can perform inter-vehicle communication with the own-vehicle M. The travel route acquisition unit 150 outputs acquired travel route information to the behavior plan generation unit 123. Specific functions of the travel route acquisition unit 150 will be described later.

The travel information provision unit 160 generates travel information of travel that the own-vehicle M has actually performed by automated driving and outputs the generated travel information to the server device via the communication device 20. This travel information is used as original information of the automated driving travel route.

The travel information includes, for example, position information of the own-vehicle M at a plurality of consecutive time points (for example, at predetermined time intervals) during traveling. The travel information may also include an image captured by the camera 10 or the like.

The interface control unit 170 controls information that is to be output to the HMI 30. The interface control unit 170 also acquires information received through the HMI 30.

The travel driving force output device 200 outputs a travel driving force (torque) required for the vehicle to travel to driving wheels. The travel driving force output device 200 includes, for example, a combination of an internal combustion engine, an electric motor, a transmission, and the like and an ECU that controls them. The ECU controls the above constituent parts according to information input from the travel control unit 141 or information input from the driving operators 80.

The brake device 210 includes, for example, a brake caliper, a cylinder that transmits hydraulic pressure to the brake caliper, an electric motor that generates hydraulic pressure in the cylinder, and a brake ECU. The brake ECU controls the electric motor according to information input from the travel control unit 141 such that a brake torque corresponding to a braking operation is output to each wheel. The brake device 210 may include, as a backup, a mechanism for transferring a hydraulic pressure generated by an operation of the brake pedal included in the driving operators 80 to the cylinder via a master cylinder. Note that the brake device 210 is not limited to that configured as described above and may be an electronically controlled hydraulic brake device that controls an actuator according to information input from the travel control unit 141 and transmits the hydraulic pressure of the master cylinder to the cylinder. The brake device 210 may also include a plurality of brake systems in consideration of safety.

The steering device 220 includes, for example, a steering ECU and an electric motor.

The electric motor, for example, applies a force to a rack-and-pinion mechanism to change the direction of steerable wheels. The steering ECU drives the electric motor according to information input from the travel control unit 141 or information input from the driving operators 80 to change the direction of the steerable wheels.

[Automated Driving Along Travel Route Acquired from External Device]

Hereinafter, automated driving along a travel route acquired from an external device will be described. For example, the own-vehicle M of the embodiment acquires, from the server device, a travel route for automated driving along which it can travel by automated driving and performs automated driving on the basis of the acquired travel route.

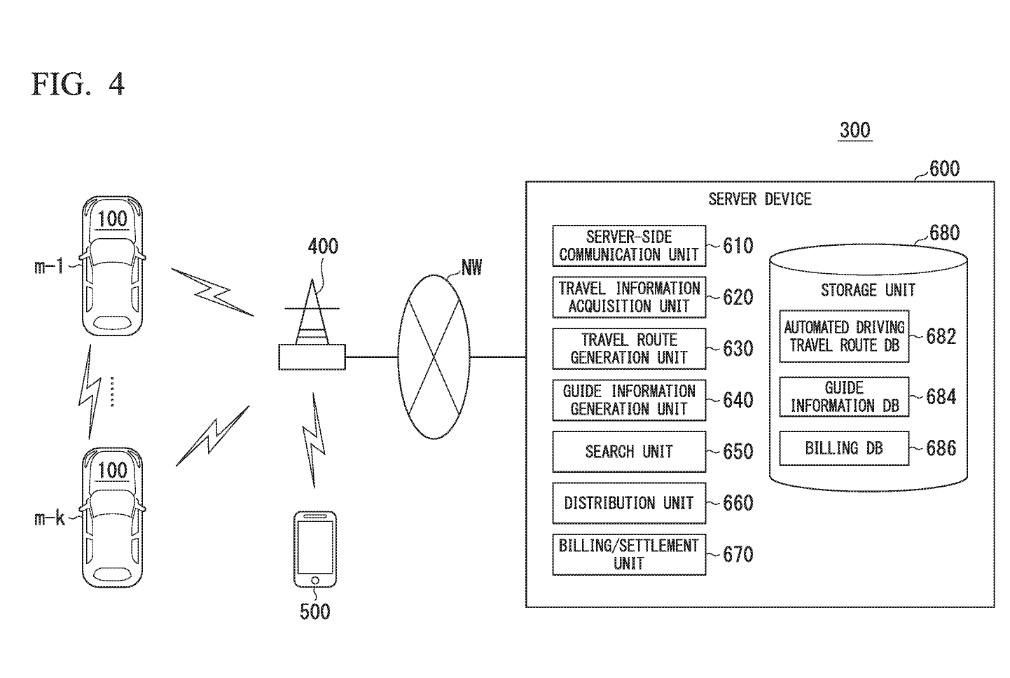

Here, a traffic information sharing system including the automated driving control unit 100 and the server device according to the embodiment will be described. FIG. 4 is a diagram showing an example of the configuration of the traffic information sharing system 300. The traffic information sharing system 300 includes a plurality of vehicles m-1 to m-k (where k is an arbitrary natural number) on each of which an automated driving control unit 100 is mounted, a base station device 400, a terminal device 500, and a server device 600. For example, the same constituent components as those of the own-vehicle M described above are mounted on each of the vehicles m-1 to m-k. Hereinafter, each of the vehicles m-1 to m-k will be simply referred to as a “vehicle m” unless they are distinguished from each other.

Wireless communication is performed between vehicles m, the base station device 400, and the terminal device 500, for example, using a mobile phone network or a Wi-Fi network. Communication is also performed between the base station device 400 and the server device 600 via a network NW. The network NW is, for example, a wide area network (WAN) or a local area network (LAN). The vehicles m communicate with the server device 600 via the base station device 400. The terminal device 500 communicates with the server device 600 via the base station device 400. The vehicles m may also directly perform inter-vehicle communication with each other.

The terminal device 500 is, for example, a terminal device used by an occupant or a user of a vehicle m. The terminal device 500 is, for example, a smartphone or a tablet terminal. The terminal device 500 accesses the server device 600 and searches for a desired travel route for automated driving. The terminal device 500 distributes a travel route obtained from the search result to a specific vehicle m identified by vehicle identification information or the like from the server device 600.

The terminal device 500 may perform registration, addition, change, update, deletion, or the like of guide information for the automated driving travel route registered in the server device 600. Such various processes for the guide information may also be performed using the HMI 30 or the like in the vehicle m. The guide information is, for example, at least one of audio information, image information, and character information. The guide information includes, for example, information regarding features that can be seen from the travel route or facilities at which it is possible to stop along the travel route. The facilities at which it is possible to stop are, for example, entertainment facilities, food and drink facilities, parks, gas stations, or convenience stores. The guide information is associated with each piece of position information of the travel route. The guide information may also include detailed travel information of the own-vehicle M on the travel route. The detailed travel information includes, for example, information regarding a recommended lane (for example, a lane in which the view is easily seen). The detailed travel information may also include travel history information (for example, the proportion of actual vehicle travel in the recommended lane).

The server device 600 includes, for example, a server-side communication unit 610, a travel information acquisition unit 620, a travel route generation unit 630, a guide information generation unit 640, a search unit 650, a distribution unit 660, a billing/settlement unit 670, and a storage unit 680. Each of the travel information acquisition unit 620, the travel route generation unit 630, the guide information generation unit 640, the search unit 650, the distribution unit 660, and the billing/settlement unit 670 is realized by a processor such as a CPU executing a program. Some or all of the functional units of the travel information acquisition unit 620, the travel route generation unit 630, the guide information generation unit 640, the search unit 650, the distribution unit 660, and the billing/settlement unit 670, which will be described below, may be realized by hardware such as an LSI, an ASIC, or an FPGA or may be realized by cooperation of hardware and software. The storage unit 680 is a storage device such as an HDD or a flash memory. The storage unit 680 stores, for example, information such as an automated driving travel route DB 682, a guide information DB 684, and a billing DB 686.

The server-side communication unit 610 acquires various types of information transmitted by the vehicle m via the base station device 400. The server-side communication unit 610 distributes information held by the server device 600 to the vehicle m. The server-side communication unit 610 also performs communication with the terminal device 500.

The travel information acquisition unit 620 acquires, for example, travel information received from the vehicle m. The travel information acquisition unit 620 may also continuously acquire travel information of the vehicle m and may collect and set, upon acquiring information indicating the termination of registration of travel information, the travel information acquired up to that time as a single piece of travel information. The travel information acquisition unit 620 may also acquire information regarding the traveling lane of the vehicle m and steering and acceleration/deceleration of the vehicle m on the basis of the travel information.

The travel route generation unit 630 generates a travel route for automated driving on the basis of travel information acquired by the travel information acquisition unit 620. The automated driving travel route is information for allowing a vehicle capable of performing automated driving to travel by automated driving on the basis of the travel route. The automated driving travel route includes, for example, position information of the vehicle m from the departure point to the destination.

The automated driving travel route may also include information regarding the traveling lane of the vehicle m and steering and acceleration/deceleration of the vehicle m. The travel route generation unit 630 may acquire a required time from the departure point to the destination on the basis of the automated driving travel route.

The travel route generation unit 630 stores the automated driving travel route generated by the travel route generation unit 630 in the storage unit 680 as the automated driving travel route DB 682 in which travel route identification information (a travel route ID) or the like is associated with a user ID.

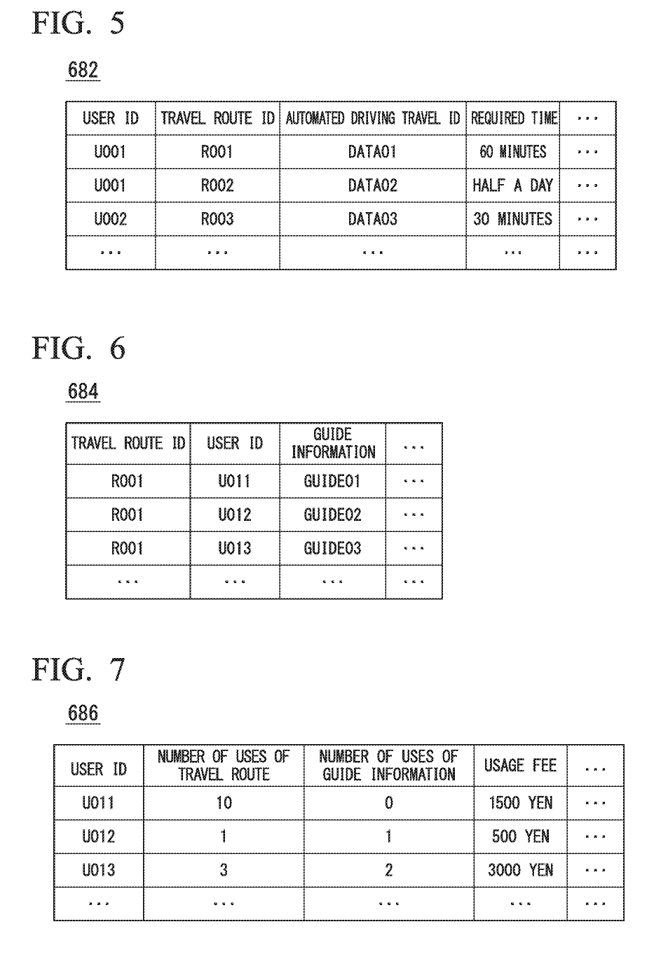

FIG. 5 is a diagram showing an example of the automated driving travel route DB 682. The user ID is, for example, information identifying the user who has registered the automated driving travel route. The travel route ID is, for example, information identifying the automated driving travel route. The automated driving travel route may include information such as a brief description, a search keyword, or the like of the travel route. The travel route generation unit 630 performs registration, addition, change, update, deletion, or the like on each record of the automated driving travel route DB 682 at predetermined times or upon receiving a user's instruction.

The guide information generation unit 640 may acquire guide information from the terminal device 500 connected via the network NW. In this case, a user of the terminal device 500 accesses the server device 600 through the terminal device 500, refers to the automated driving travel route DB 682, and inputs guide information for the automated driving travel route that is referred to.

The guide information generation unit 640 may also acquire, for example, guide information corresponding to the automated driving travel route DB 682 from the vehicle m, which has transmitted the automated driving travel route, via the network NW.

The guide information generation unit 640 stores guide information acquired by the guide information generation unit 640 in the storage unit 680 as the guide information DB 684 in which the guide information is associated with a travel route ID, a user ID of a user who has provided the guide information, and the like. FIG. 6 is a diagram showing an example of the guide information DB 684. The user ID of the guide information DB 684 is information identifying the user who has registered the guide information. The user may be, for example, an occupant of the vehicle m or an owner of the terminal device 500.

When a plurality of pieces of guide information are present for a travel route for automated driving, the guide information generation unit 640 distinguishes and stores them by user IDs, registration dates, or the like. The guide information generation unit 640 performs registration, addition, change, update, deletion, or the like on each record of the guide information DB 684 at predetermined times or upon receiving a user's instruction.

The search unit 650 refers to the automated driving travel route DB 682 on the basis of a search condition of a travel route from the vehicle m or the terminal device 500 and extracts information regarding an automated driving travel route and a required time corresponding to the search condition. The search condition is, for example, at least one of a search keyword, time information, information regarding the destination, and the like. The search unit 650 may combine and extract a plurality of automated driving travel routes corresponding to the search condition. When the required time is 45 minutes as a search condition, the search unit 650 extracts automated driving travel routes of 15 minutes and 30 minutes from the automated driving travel route DB 682 and determines whether or not the travel routes are connectable from respective position information of the travel routes and, when the travel routes are connectable, combines the travel routes and extracts the combination of the travel routes as a single automated driving travel route.

The search unit 650 refers to the guide information DB 684 on the basis of identification information of the extracted travel route and extracts guide information corresponding to the identification information of the travel route. The search unit 650 transmits the travel route and the guide information extracted in the search to the vehicle m or the terminal device 500 which has made the search request through the server-side communication unit 610. Also, when a request to acquire additional guide information based on the current position of the vehicle m has been made, the search unit 650 may refer to the guide information DB 684, extract guide information corresponding to identification information of the travel route, and transmit the extracted guide information to the vehicle m which has made the search request.

The distribution unit 660 transmits a search result including the automated driving travel route, the required time, the guide information corresponding to the automated driving travel route, and the like obtained by the search unit 650 to the vehicle m or the terminal device 500 from which the search request has been received through the server-side communication unit 610. When a plurality of search results have been obtained by the search unit 650, the distribution unit 660 may combine and distribute the plurality of search results to the vehicle m or the terminal device 500 which has made the search request. Further, the distribution unit 660 may also start distributing the automated driving travel route to a vehicle m identified by communication with the terminal device 500 on the basis of a start instruction from the terminal device 500.

The billing/settlement unit 670 bills an occupant using the automated driving travel route or the guide information stored in the server device 600. For example, the billing/settlement unit 670 may perform charging on the basis of the number of uses of the automated driving travel route DB 682 or the guide information DB 684 or may perform charging of a fixed fee for each month. The billing/settlement unit 670 may also variably set the fee for each of the automated driving travel route information 872 and the guide information DB 684. The billing/settlement unit 670 may not bill a fee for the use of a travel route when an actual time spent traveling on the travel route significantly exceeds a preset required time corresponding to the travel route. The actual spent time is assumed as significantly exceeding the preset required time, for example, when the excess time is equal to or longer than a predetermined time. The billing/settlement unit 670 stores the billed fee in the storage unit 680 as a billing DB 686 in which the billed fee is associated with a user ID of the user, the number of uses, and the like.

FIG. 7 is a diagram showing an example of the billing DB 686. In the billing DB 686, the number of uses of each of the automated driving travel route information and the guide information and a total usage fee for the number of uses are stored in association with each user ID. The usage fee may be billed at regular intervals or may be billed for each use of the travel route or guide information.

For example, when settlement is completed for a user, the billing/settlement unit 670 may delete the content of the user's data from the billing DB 686. The billing/settlement unit 670 may also pay an amount of money or predetermined points to a user who has provided travel route information or a user who has provided guide information, for example, on the basis of the number of times of use. This can increase the motivation of the user to register travel routes or guide information in the server device 600.

### [Acquisition of Automated Driving Travel Route]

Next, a process of the own-vehicle M acquiring an automated driving travel route from the server device 600 will be described in detail. Upon receiving an instruction to acquire a travel route for automated driving from an occupant through the display device 31 or the various operating switches 34 of the HMI 30, the travel route acquisition unit 150 makes a request to acquire a travel route from the server device 600 via the communication device 20. In this case, the interface control unit 170 outputs to the display device 31 a screen that allows the occupant to input a search condition for the travel route.

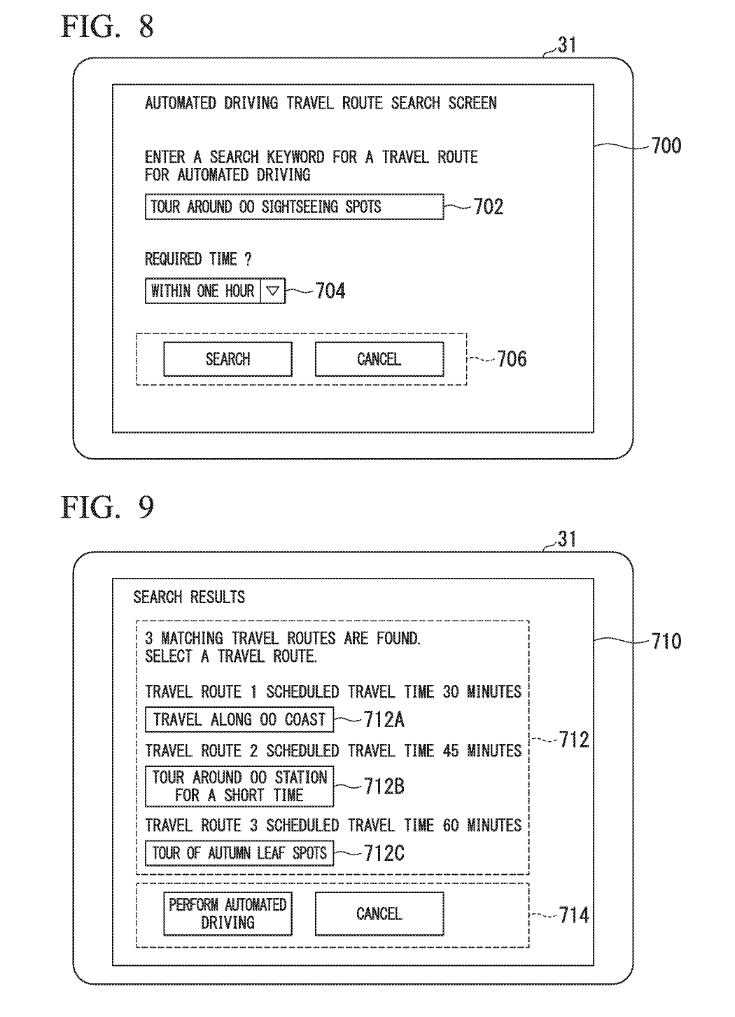

FIG. 8 is a diagram showing an example of a search screen 700 for a travel route for automated driving displayed on the display device 31. Upon receiving a request to acquire a travel route for automated driving from the occupant of the own-vehicle M, the interface control unit 170 outputs the search screen 700 as shown in FIG. 8 to the display device 31.

In the example of FIG. 8, for example, a search keyword input area 702, a required time setting area 704, and a GUI switch display area 706 are displayed on the search screen 700. The search keyword input area 702 is a region for receiving an input of information such as a place to which the occupant wants to go and the purpose of travel. In the example of FIG. 8, a keyword such as “tour around OO sightseeing spots” is entered into the search keyword input area 702. When the own-vehicle M is in heavy traffic at the time at which the search condition is entered, the occupant may enter a phrase such as “avoid traffic” into the search keyword input area 702. The interface control unit 170 may display GUI buttons such as “sightseeing” and “avoid traffic” in the search keyword input area 702 and extract a search condition corresponding to a selected GUI button.

The required time setting area 704 is a region for receiving an input of information regarding the required time for traveling by automated driving. The required time setting area 704 is a combo box type of GUI element which allows selection of one of preset times. The required time setting area 704 may also be a list box type of GUI element. For example, when there is idle time, setting the required time as one of the search conditions allows the occupant to acquire a travel plan corresponding to the idle time from an external device, thus causing the own-vehicle M to travel accordingly. This allows the occupant to enjoy entertainment such as sightseeing according to the travel plan effectively using idle time or the like.

The GUI switch display area 706 includes, for example, a search button for performing a search for a travel route with the search condition entered into at least one of the search keyword input area 702 or the required time setting area 704 and a cancel button for stopping the travel route search. The occupant may enter information into the search keyword input area 702 and the required time setting area 704 shown in FIG. 8, for example, by manually using the touch panel of the display device 31 or by voice input through the microphone 33. The interface control unit 170 may also receive an input of a search condition or the like by reading a gesture of the occupant from an image captured by the vehicle interior camera 90 or by reading the intention of the occupant through another method.

On the basis of the information received from the search screen 700 shown in FIG. 8, the travel route acquisition unit 150 outputs a request to acquire an automated driving travel route to the server device 600 via the communication device 20. Note that the travel route acquisition unit 150 may transmit position information of the own-vehicle M together with the request to acquire the travel route.

In addition, the travel route acquisition unit 150 outputs a search response corresponding to the search condition received from the server device 600 to the display device 31. FIG. 9 is a diagram showing an example of a search result screen displayed on the display device 31. In the example of FIG. 9, the search result screen 710 displayed on the display device 31 includes, for example, a search result display area 712 and a GUI switch display area 714. The number of automated driving travel routes obtained from search results is displayed in the search result display area 712.

When there are a plurality of search results, a required time for travel corresponding to each automated driving travel route and information regarding the content of the automated driving travel route are displayed in the search result display area 712.

The interface control unit 170 displays GUI buttons 712A, 712B, and 712C for selecting one of the travel routes obtained from the search results on the display device 31. This allows the occupant to easily select one of a plurality of travel routes.

In the example of FIG. 9, brief descriptions of travel routes are shown in the display areas of the GUI buttons 712A. 712B, and 712C. However, the interface control unit 170 may not display descriptions of travel routes. This makes it possible to select a route from the three routes without being aware of which travel plans the three routes correspond to. This allows the occupant to have a sense of anticipation regarding which place he/she will go by automated driving and thus to enjoy driving. The interface control unit 170 may display a description of the travel route upon receiving an instruction from the occupant or may display a description of the travel route on the display device 31 upon the termination of traveling on the travel route.

The GUI switch display area 714 includes, for example, an automated driving execution button for performing automated driving along the selected travel route and a cancel button for canceling automated driving along the travel routes obtained from the search results. The occupant selects one of the GUI buttons 712A to 712C and then selects the automated driving execution button. The travel route acquisition unit 150 outputs information of the travel route selected by the occupant to the behavior plan generation unit 123.

The behavior plan generation unit 123 generates a target trajectory for traveling along the automated driving travel route acquired by the travel route acquisition unit 150. The behavior plan generation unit 123 generates the target trajectory of the own-vehicle M on the basis of the automated driving travel route input from the travel route acquisition unit 150, traveling states of nearby vehicles recognized by the external environment recognition unit 121, and traveling states of the own-vehicle M recognized by the own-vehicle position recognition unit 122. The travel control unit 141 realizes safe automated driving along the generated target trajectory.

When there is guide information corresponding to position information of the location on or near the travel route while the automated driving is being performed along the travel route, the interface control unit 170 outputs the guide information through the HMI 30. For example, when the guide information is audio information, the interface control unit 170 outputs corresponding audio information through the speaker 32. When the guide information is image information, the interface control unit 170 outputs corresponding image information through the display device 31. This makes it possible to change lanes during automated driving, to easily see the view, to provide voice guidance about spots to be seen, recommended points, precautionary notes, or the like or to notify the occupant of descriptions of features or facilities.

Upon receiving an operation of making a request to acquire additional guide information through the HMI 30, the travel route acquisition unit 150 determines whether or not the own-vehicle M is located on the travel route. Upon determining that the own-vehicle M is located on the travel route, the travel route acquisition unit 150 may make a request to acquire additional guide information from the server device 600 to acquire the additional guide information. The interface control unit 170 outputs the additional guide information through the HMI 30. This allows the occupant to acquire more information regarding the travel route.

The interface control unit 170 may allow the seat device 40 to be driven in accordance with position information of the location on the travel route while automated driving is being performed along the travel route. In this case, the interface control unit 170 may allow the seat surface of the occupant seat to rotate toward the window on the basis of the relationship between the travel route and the position of the vehicle at a place with a good landscape, such that the occupant can easily see the landscape. This allows the occupant to enjoy the landscape without changing his/her posture. The interface control unit 170 may also allow the seat device 40 to continuously rotate toward the landscape in accordance with the relative position or direction between the moving own-vehicle M and the landscape such that the seat device 40 follows the landscape until the landscape is spaced apart from the own-vehicle M by a predetermined distance or more.

### [Provision of Travel Information]

Next, a process of providing travel information that is to be registered in the server device 600 from the own-vehicle M will be described in detail. The travel information provision unit 160 acquires travel information of travel that the own-vehicle M has actually performed and transmits the generated travel information to the server device 600 via the communication device 20.

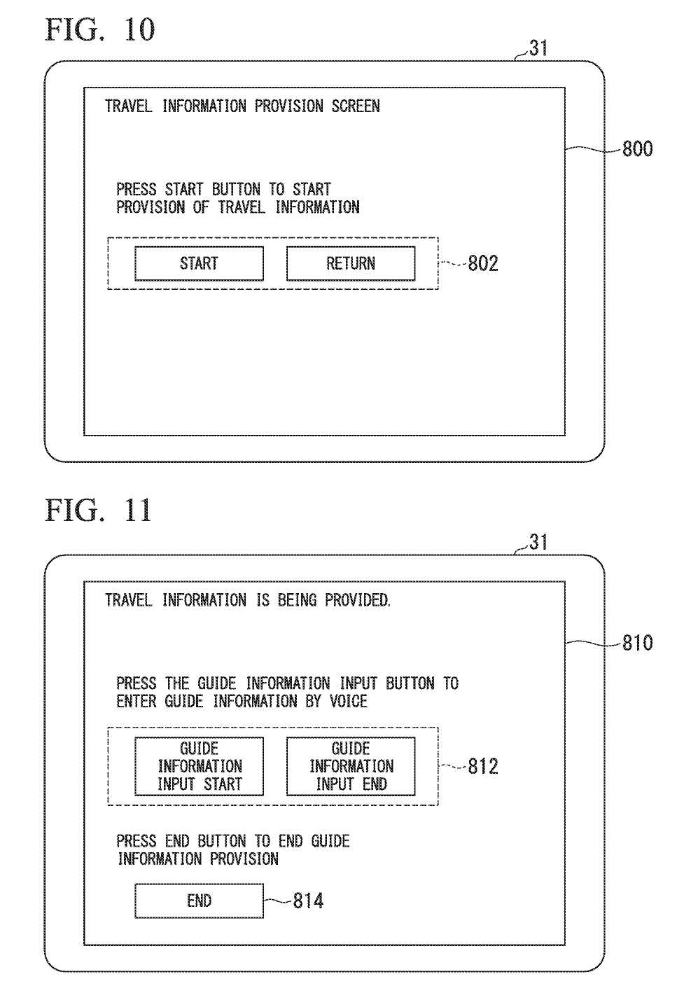

FIG. 10 is a diagram showing an example of a travel information provision screen. The interface control unit 170 displays a travel information provision screen 800 on the screen of the display device 31. For example, a GUI switch display area 802 is displayed on the travel information provision screen 800. The GUI switch display area 802 includes, for example, a start button for receiving an operation of starting generation of travel information and a return button for switching to a previous screen.

Upon receiving an operation of selecting the start button through the display device 31, the travel information provision unit 160 transmits the travel information to the server device 600 via the communication device 20 until the own-vehicle M receives an instruction to end the provision of the travel information.

FIG. 11 is a diagram showing an example of a screen displayed on the display device 31 during provision of travel information.

For example, a guide information input selection area 812 for inputting guide information by voice during provision of travel information and a GUI switch 814 for ending the provision of travel information are displayed on the screen 810 during provision of travel information as shown in FIG. 11.

Upon receiving an operation of selecting a guide information input start button displayed in the guide information input selection area 812 through the display device 31, the travel information provision unit 160 acquires audio information input through the microphone 33 and associates the acquired audio information with traveling position information of the own-vehicle M included in the travel information and then transmits the acquired audio information associated therewith to the server device 600 via the communication device 20.

Upon receiving an operation of selecting a guide information input end button displayed in the guide information input selection area 812 through the display device 31, the travel information provision unit 160 ends receiving audio information through the microphone 33. In the case in which both guide information and character information are received, the travel information provision unit 160 acquires characters, symbols, or the like input using GUI keys or the like displayed on the display device 31 as guide information.

Upon receiving an operation of selecting the GUI switch 814 for ending the provision of travel information through the display device 31, the travel information provision unit 160 transmits information indicating the end of the provision of travel information to the server device 600. Thus, it is possible to register travel information of travel that the own-vehicle M has actually performed in the server device 600 as a travel plan.

The travel information provision unit 160 may also store a series of travel information or guide information from the start to the end without continuously transmitting the travel information or guide information to the server device 600 and may then combine and transmit the stored travel information to the server device 600 at a predetermined time.

The travel information provision unit 160 may also store travel information or guide information in a storage device such as an HDD or a flash memory of the automated driving control unit 100 without transmitting the travel information or guide information to the server device 600 such that the travel information or guide information can be used only by the own-vehicle M.

### [Vehicle Control Process]

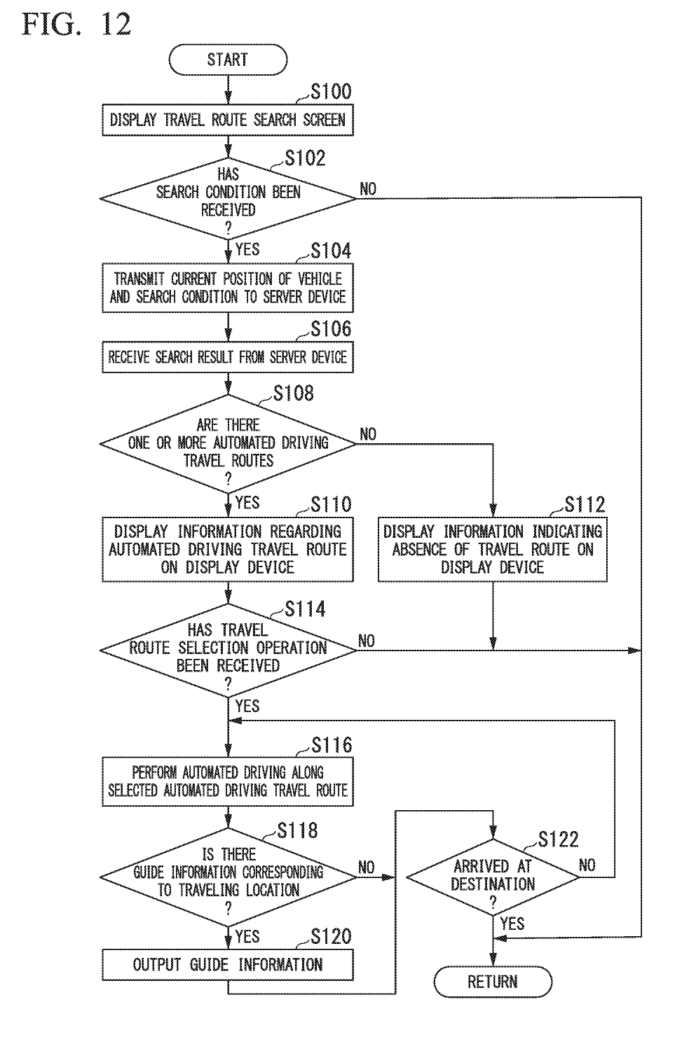

Hereinafter, various vehicle control by the vehicle system 1 according to the embodiment will be described. FIG. 12 is a flowchart showing an example of a process of acquiring an automated driving travel route. First, the interface control unit 170 displays a search screen for a travel route for automated driving on the display device 31 on the basis of an operation from the occupant (step S100). Next, the interface control unit 170 determines whether or not a search condition has been received through the search screen (step S102). Next, the travel route acquisition unit 150 transmits the current position of the vehicle and the search condition to the server device 600 (step S104). Next, the travel route acquisition unit 150 receives a search result from the server device 600 (step S106) and determines whether or not there are one or more automated driving travel routes (step S108).

When there are one or more automated driving travel routes, the interface control unit 170 displays information regarding the automated driving travel routes of the search result on the display device 31. If there is no automated driving travel route, the interface control unit 170 displays information indicating that there is no automated driving travel route on the display device 31 (step S112).

Next, the interface control unit 170 determines whether or not an operation of selecting a travel route for automated driving has been received through the display device 31 (step S114). When an operation of selecting a travel route for automated driving has been received, automated driving is performed along the selected automated driving travel route (step S116). Next, the travel route acquisition unit 150 determines whether or not there is guide information corresponding to (position information of) a traveling location of the own-vehicle M (step S118). When there is guide information for the traveling location, the interface control unit 170 outputs guide information corresponding to the traveling location to the HMI 30 (step S120). Next, the behavior plan generation unit 123 determines whether or not the own-vehicle M has arrived at the destination (step S122). If the own-vehicle M has not arrived at the destination, the process returns to step S16. When the own-vehicle M has arrived at the destination, the process of this flowchart ends. The process of this flowchart also ends when it is determined in the process of step S102 that no search condition has been received or after the process of S112 is completed.

According to the procedure described above, the automated driving control unit 100 can cause the own-vehicle M to be automatically driven on the basis of the travel route acquired from the server device 600. Thus, the vehicle can be automatically driven along a travel route desired by the occupant. According to the embodiment, the own-vehicle M can also be caused to travel, for example, on the basis of a travel route created by a third party.

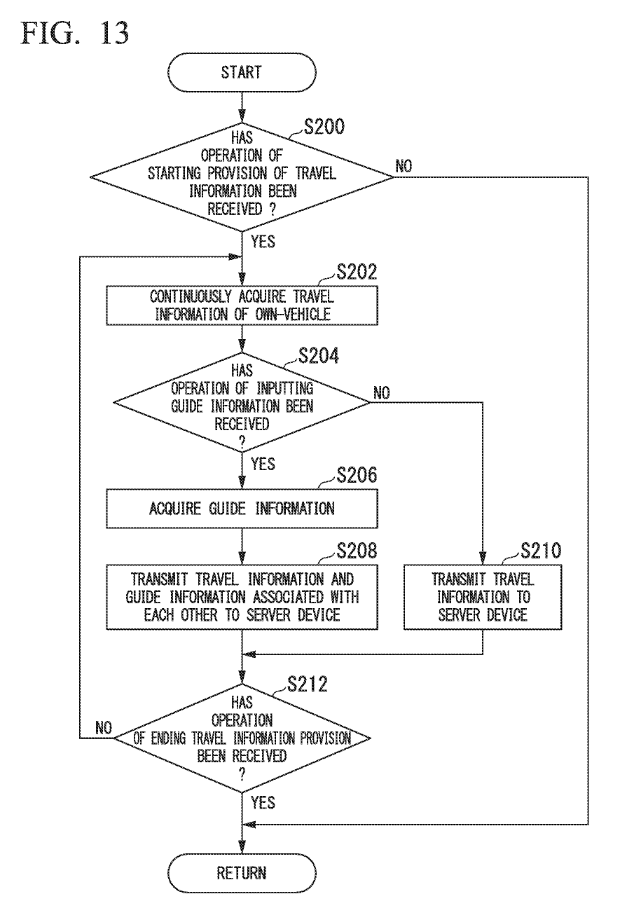

Next, a process of providing travel information from the own-vehicle M will be described. FIG. 13 is a flowchart showing an example of the process of providing travel information.

First, the interface control unit 170 determines whether or not an operation of starting provision of travel information has been received through the display device 31 (step S200). The interface control unit 170 may also receive an operation of starting provision of travel information by voice input through the microphone 33 or the like.

Upon receiving an operation of starting provision of travel information, the travel information provision unit 160 acquires travel information of the own-vehicle M (step S202). Next, the interface control unit 170 determines whether or not an operation of inputting guide information has been received through the display device 31 (step S204). When an operation of inputting guide information has been received, the travel information provision unit 160 acquires the guide information (step S206) and transmits the travel information of the own-vehicle M and the guide information which are associated with each other to the server device 600 (step S208). When no operation of inputting guide information has been received, the travel information provision unit 160 transmits the travel information of the own-vehicle M to the server device 600 (step S210).

Next, the interface control unit 170 determines whether or not an operation of ending the provision of travel information has been received through the display device 31 (step S212). When no operation of ending the provision of travel information has been received, the process returns to step S202. When an operation of ending the provision of travel information has been received, the process of this flowchart ends. The process of this flowchart also ends when it is determined in the process of step S200 that no operation of starting the provision of travel information has been received.

According to the procedure described above, the automated driving control unit 100 can provide an actually traveled route to other vehicles. The automated driving control unit 100 can also provide landscapes, precautionary notes about traveling, or the like which can be obtained from actual travel as guide information or the like.

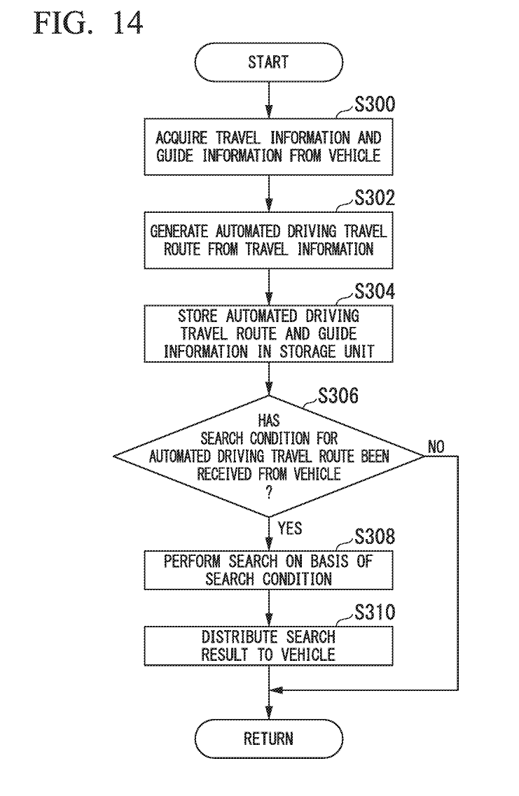

Next, processes performed in the server device 600 will be described. FIG. 14 is a flowchart showing an example of a process of sharing traffic information in the server device 600. First, the travel information acquisition unit 620 acquires travel information and guide information from a vehicle (step S300). In the process of step S300, only travel information may be acquired. Travel information and guide information may also be acquired from different users. Next, the travel route generation unit 630 generates a travel route for automated driving from the travel information (step S302). Next, the travel route generation unit 630 stores the automated driving travel route and guide information in the storage unit 680 (step S304). In this case, the travel route generation unit 630 stores only the travel information when there is no guide information.

Next, the search unit 650 determines whether or not a search condition for a travel route has been received from a vehicle m (step S306). Upon receiving a search condition for a travel route from a vehicle, the search unit 650 searches information stored in the storage unit 680 on the basis of the received search condition (step S308) and transmits a search result to the vehicle which has issued the search instruction (step S310). Then, the process of this flowchart ends. The process of this flowchart also ends when it is determined in the process of step S306 that no search condition for a travel route has been received from vehicles.

According to the procedure described above, the server device 600 distributes a travel route for automated driving generated from information of travel that a vehicle m has actually performed, which allows automated driving to be performed according to actual road states or the like. Thus, for example, the server device 600 can cause the vehicle m to travel on the basis of a travel plan created by a third party.

Further, according to the procedure described above, an occupant can provide other vehicles with alternative ways upon traffic congestion or sightseeing courses created by himself or herself. Thus, the occupant can provide, for example, an original travel plan which allows vehicles to travel slowly in a place with a good landscape. Furthermore, according to the procedure described above, it is possible, for example, to provide other vehicles with a travel route which only local people know.

### [Modification]

Here, a modification of the embodiment will be described. The above embodiment has been described with reference to the case in which a travel route itself is route information dedicated for automated driving, but the present invention may also be applied when acquiring a travel route on which it is possible to travel regardless of automated driving or manual driving. In this case, the travel route generation unit 630 of the server device 600 generates a travel route on which it is possible to travel regardless of automated driving or manual driving.

The travel route acquisition unit 150 acquires the travel route generated by the server device 600. The behavior plan generation unit 123 determines from the acquired travel route, for example, whether or not automated driving can be performed on the travel route according to the automated driving level or the automated driving function of the own-vehicle M. The automated driving level is, for example, a level at which items to be controlled by automated driving are set stepwise such as a level at which all vehicle control is automatically performed or a level at which vehicle control of acceleration/deceleration or steering is automatically performed. The automated driving function is a function to realize, for example, travel which matches the automated driving level. Then, upon determining that automated driving can be performed on the acquired travel route, the behavior plan generation unit 123 performs automated driving along the section of the travel route in which automated driving can be performed.

The behavior plan generation unit 123 may also acquire a region in which automated driving is possible in the travel route acquired by the travel route acquisition unit 150 and may perform automated driving in the acquired region. In this case, for example, the behavior plan generation unit 123 acquires both a region of the travel route acquired by the travel route acquisition unit 150 in which the own-vehicle M can travel and any of the automated driving levels of the own-vehicle M at which the own-vehicle M can travel and presents the acquired information to the occupant through the HMI 30 and then performs automated driving in the region upon receiving an instruction to perform automated driving according to the presented information from the occupant. This allows the own-vehicle M to travel on the acquired travel route with manual driving and automated driving in combination.

According to the vehicle control system, the server device, the vehicle control method, and the vehicle control program in the above-described embodiment, it is possible to cause the vehicle to be automatically driven on a travel route according to a request of the occupant. In addition, according to the embodiment, it is possible to achieve information sharing by allowing the server device 600 to manage travel routes and guide information. Therefore, the server device 600 can provide high value-added services to the occupant of the vehicle.

Further, according to the embodiments, a travel route(s) can be downloaded to the own-vehicle M in advance by accessing the server device 600 using the terminal device 500 possessed by the occupant of the own-vehicle M such that the own-vehicle M can be automatically driven on a desired travel route immediately after the occupant gets in the own-vehicle M.

According to the embodiments, for example, it is also possible to provide a service of allowing an occupant to store a travel plan he/she has designed in a vehicle M and lending the vehicle M itself to him/her. Further, according to the embodiments, it is possible to provide a service of allowing a travel route for automated driving to be downloaded to a vehicle M for rental and lending the vehicle M, to which the travel route has been downloaded, to the user. Thus, it is possible to provide a service of providing vehicles for individual tours or the like.

In addition, in the embodiments, the automated driving control unit 100 may acquire a captured image, guide information, or the like corresponding to a search condition from the server device 600 and may output the acquired captured image or guide information to the HMI 30 or may display the acquired captured image or guide information on each window of the own-vehicle M. This allows the occupant to virtually experience the landscape or the like when the own-vehicle M travels on the travel route without causing the own-vehicle M to actually travel.

Although the mode for practicing the present invention has been described by way of embodiments, the present invention is not limited to these embodiments and various modifications and substitutions may be made without departing from the spirit of the present invention.

What is claimed is:

1. A vehicle control system comprising:
a travel route acquisition unit configured to acquire a travel route, on which a vehicle can travel, from an external device; and
a travel control unit configured to at least partly automatically perform travel control of the vehicle and to cause the vehicle to travel on the basis of the travel route acquired by the travel route acquisition unit.

2. The vehicle control system according to claim 1, wherein the travel route acquisition unit is configured to acquire, together with the travel route, guide information regarding a feature that can be seen from the travel route or a facility at which it is possible to stop along the travel route.

3. The vehicle control system according to claim 2, wherein the guide information includes detailed travel information of the vehicle on the travel route.

4. The vehicle control system according to claim 3, wherein the detailed travel information includes information regarding a recommended lane.

5. The vehicle control system according to claim 3, wherein the detailed travel information includes a proportion of actual vehicle travel in a recommended lane.

6. The vehicle control system according to claim 2, wherein the travel route acquisition unit is configured to determine whether or not the vehicle is located on or near the travel route and to acquire the guide information from the external device on the basis of a result of the determination.

7. The vehicle control system according to claim 1, further comprising a position information acquisition unit configured to acquire position information of the vehicle,
wherein the travel route acquisition unit is configured to acquire, from the external device, a travel route, on which it is possible to travel at a predetermined time, using the position information of the vehicle acquired by the position information acquisition unit.

8. The vehicle control system according to claim 1, further comprising an interface unit configured to receive an operation from an occupant of the vehicle,
wherein, when an operation of starting provision of original information of the travel information is received through the interface unit, the position information of the vehicle is transmitted to the external device until the occupant performs an operation of ending provision of the original information of the travel route.

9. A vehicle control system comprising:
a travel route acquisition unit configured to acquire a travel route, on which a vehicle can travel, from an external device;
a determination unit configured to determine whether or not it is possible to travel by automated driving on the travel route acquired by the travel route acquisition unit; and
a travel control unit configured to at least partly automatically perform travel control of the vehicle and to cause the vehicle to travel on the basis of the travel route acquired by the travel route acquisition unit when the determination unit has determined that it is possible to travel by automated driving.

10. A vehicle control system comprising:
a travel route acquisition unit configured to acquire a travel route, on which a vehicle can travel, from an external device;
a region acquisition unit configured to acquire a region in which it is possible to travel by automated driving in the travel route acquired by the travel route acquisition unit; and
a travel control unit configured to at least partly automatically perform travel control of the vehicle and to cause the vehicle to travel in the region acquired by the region acquisition unit.

11. A server device comprising:
a travel information acquisition unit configured to acquire original information of a travel route, on which it is possible to travel by automated driving, from a vehicle;
a travel route generation unit configured to generate a travel route on which it is possible to travel by automated driving on the basis of information acquired by the travel information acquisition unit; and
a distribution unit configured to distribute the travel route generated by the travel route generation unit to the vehicle.

12. The server device according to claim 11, further comprising a guide information generation unit configured to generate guide information corresponding to the travel route generated by the travel route generation unit,
wherein the distribution unit is configured to further distribute the guide information corresponding to the travel route to the vehicle.

13. The server device according to claim 11, further comprising a communication unit configured to communicate with a terminal device of a user of the vehicle,
wherein the distribution unit is configured to start distributing the travel route generated by the travel route generation unit to the vehicle recognized by communication with the terminal device on the basis of a start instruction from the terminal device.

14. A vehicle control method causing a vehicle-mounted computer to:
acquire a travel route, on which a vehicle can travel, from an external device; and
at least partly automatically perform travel control of the vehicle and cause the vehicle to travel on the basis of the acquired travel route.

15. A vehicle control program causing a vehicle-mounted computer to:
acquire a travel route, on which a vehicle can travel, from an external device; and
at least partly automatically perform travel control of the vehicle and cause the vehicle to travel on the basis of the acquired travel route.
